(19) United States
(12) Patent Application Publication
(10) Pub. No.: US 2023/0267680 A1
(43) Pub. Date: Aug. 24, 2023

(54) SYSTEM AND METHOD OF CREATING A DIGITAL REPLICA

(71) Applicant: Fritz Lamour, Port Saint Lucie, FL (US)

(72) Inventor: Fritz Lamour, Port Saint Lucie, FL (US)

(21) Appl. No.: 18/111,593

(22) Filed: Feb. 19, 2023

Related U.S. Application Data
(60) Provisional application No. 63/312,068, filed on Feb. 20, 2022.

(51) Int. Cl. G06T 17/00; G06V 40/16; G10L 13/02; G10L 15/18; G06F 21/32; H04L 51/04

(52) U.S. Cl. CPC G06T 17/00; G06V 40/171; G10L 13/02; G10L 15/1815; G06F 21/32; H04L 51/04

(57) ABSTRACT

A system for creating a digital replica is disclosed. An image class module processes and analyzes images and other visual data related to a specific user, and displays the data to reflect the user's intent. A speech class module synthesizes and transmits speech data related to the user. A digital class module processes and manipulates visual data related to the user. An intelligence class module enables the digital replica to engage in conversation with others. A record class module stores and organizes data related to the user and allows for efficient retrieval of the data as needed.

### CROSS-REFERENCE TO RELATED APPLICATIONS

This application claims priority to U.S. Provisional Patent Application Ser. No. 63/312,068, filed Feb. 20, 2022, titled “SYSTEM AND METHOD FOR PERSONAL DEVELOPMENT USING AVATARS, FOLDERS AND HARDWARE”, hereby incorporated by reference in its entirety for all of its teachings.

### TECHNICAL FIELD

The present invention relates to digital replicas. More specifically, this invention relates to developing, protecting and expressing user digital identities and interacting with other users through protocols that verify authenticity.

### BACKGROUND OF THE INVENTION

Chatbots and personal assistants are computer programs designed to simulate conversation with human users. They have been implemented in a variety of applications that include customer service, e-commerce, and personal productivity to name just a few.

Some of the earliest chatbot systems were rule-based. They used sets of predefined rules to determine user input responses. More recent systems use techniques such as natural language processing and machine learning.

Personal assistants, such as Apple's Siri and Amazon's Alexa, are a specific type of chatbot. They are designed to assist users with scheduling tasks, setting reminders, and controlling smart home devices for example. Voice recognition and natural language processing are used by such systems to understand and respond to user requests.

In recent years, conversational AI has aimed to create more human-like interactions between users and chatbots. The development of more advanced techniques such as deep learning, reinforcement teaming, and generative models have improved the ability of chatbots to understand and generate natural language.

The field of chatbots and personal assistants, overall, is a rapidly evolving area of technology, with a wide range of prior art and ongoing research and development.

U.S. Pat. No. 10,853,717, entitled “Creating a Conversational Chat Bot of a Specific Person”, by Microsoft (“Microsoft Patent”) teaches a method of creating a conversation chat bot of a specific person based on a style of the user. Social data such as images, voice data, social media posts, electronic messages, written letters, etc., about the specific person may be accessed to create or modify a special index in the theme of the specific person's personality. The special index is used to train a chat bot to converse in the personality of the specific person. During such conversations, a variety of data sources may be used to reply to user dialogue and/or questions. In some aspects, a 2D or 3D model of a specific person is generated using images, depth information, and/or video data associated with the specific person.

The Microsoft Patent does not grant users administrative rights. Nor does it discuss digital replica to replica messaging. The Microsoft Patent also does not discuss using facial and voice recognition as part of a security protocol.

### SUMMARY OF THE INVENTION

Disclosed herein is a metaverse system that grants users administrative rights. Principle among these rights is the ability for one to control the real-time generation of their own 3D morphable face model and unique voice font, assets that are tied to one's account ID and synced with login information and settings preferences. Also employed by the system is a mirroring effect, where mirroring neurons fire both when a user acts and when they observe the same action taken by their digital replica, creating a psychologically profound experience. Optimized for mimicry, one aim of the disclosure is in the improvement of users' lives in a measurable way. This includes a combination of user profiles, system knowledge bases, plus personality and solution indexes that result in the output of visual, logical, and audio data. The system also includes a user profile creation process. This allows for the initiation, storage, and analysis of user data and the creation of intermediate profiles. Designed to continually output personalized data to users, based on their profile and the system's knowledge base, the system can provide user performance feedback. Also featured is facial and voice recognition technology.

Digital replicas are able to determine the identity of their user as a result. This serves as a security measure to prevent cyber threats.

The system includes but is not limited to several modules that perform various functions related to creating and interacting with these digital replicas. These modules include:

An image class module that is responsible for image analysis, image recognition, image processing, and display of user graphical intent. It is used to process and analyze images and other visual data related to the specific individual or entity, and to display this data in a way that reflects the user's intent.

A speech class module that is responsible for speech signal synthesis, speech storage, speech transmission, speech recognition, and display of user speech intent. It is used to synthesize and transmit speech data related to the specific individual or entity, as well as to recognize and interpret speech inputs from users.

A digital class module that is responsible for digital data processing for visual presentation, creation, and manipulation of graphic objects. It is used to process and manipulate visual data related to the specific individual or entity, and to create and present this data in a visually appealing manner.

An intelligence class module that is responsible for emulation of intelligence. It is used to enable the digital replicas to engage in intelligent and realistic conversation with users. Finally, a record class module is responsible for record storage, organization, indexation, and retrieval through a computerized data process. It is used to store and organize data related to the specific individual or entity, and to allow for efficient retrieval of this data as needed.

A method of creating a digital replica using this system involves accessing social data related to the specific individual or entity, and using this data to create or modify a special index in the theme of the individual or entity's personality. This special index is then used to train a chatbot to converse and interact in the personality of the specific individual or entity. During conversations with users, the digital replica may use one or more conversational data stores and/or APIs to reply to user dialogue and/or questions for which the social data does not provide sufficient data. The system may also generate a voice font of the specific individual or entity using recordings and sound data related to the individual or entity, and may generate a 2D or 3D model of the individual or entity using images, depth information, and/or video data associated with the individual or entity.

### BRIEF DESCRIPTION OF DRAWINGS

FIG. 1 illustrates a macro view of the system for creating user-generated digital replicas as described herein, in accordance with one embodiment of the present invention.

FIG. 2 illustrates a process of generating digital replicas and voice fonts for a specific person as described herein, in accordance with one embodiment of the present invention.

FIG. 3 illustrates a system for enabling user-generated digital replicas to message one another as described herein, in accordance with one embodiment of the present invention,

FIG. 4 illustrates a system for engineering a virtual community secured by facial and voice recognition as described herein, in accordance with one embodiment of the present invention.

FIG. 5 illustrates a system for providing administrative rights to a user in the system for creating user-generated digital replicas as described herein, in accordance with one embodiment of the present invention.

### DETAILED DESCRIPTION OF INVENTION

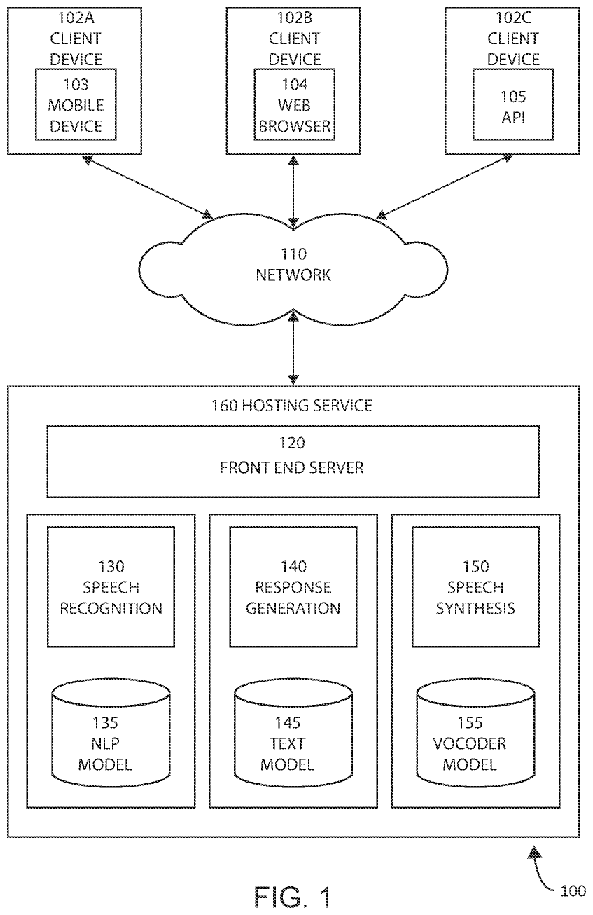

FIG. 1 illustrates a macro view of a system 100 for creating user-generated digital replicas as described herein. System 100 includes several modules that perform various functions related to creating and interacting with these digital replicas. System 100 may consist of both hardware and software components in certain embodiments. The hardware may be used to run an operating system, while the software may include applications, APIs, modules, virtual machines, and runtime libraries. System 100 may provide an environment for these software components to execute, evaluate operational constraint sets, and use the resources and facilities of the system 100. This environment may be installed on one or more processing devices, such as computers, mobile devices, or other electronic devices. In some cases, the components of system 100 may be distributed across multiple devices and accessed over a network. System 100 comprises several modules that are specifically designed to carry out specific functions. These functions are all integral to the creation and manipulation of digital replicas.

Client devices 102A-C may provide a personality index or personalized personality index to a digital replica. This digital replica may be located on a local device, a server, or a combination of both. This digital replica may use the personality index as input to train itself to interact in a way that is consistent with the personality or personalities specified in the index. For example, client devices 102A-C may provide a personalized personality index to a digital replica, which is then trained to interact conversationally in the personality of the specific person associated with the index. The trained, personalized digital replica may then be transmitted to one or more client devices or server devices, and a network module 110 which facilitates the sending and receiving of data over a network.

Client devices 102A-C may also have access to one or more chat indexes, which are repositories of conversational data including social data and algorithms related to a variety of users, events, and conversational scenarios. A chat index may include question and answer information from a specific person, similar individuals, a group of users, or a portion of a community, as well as general information about a specific person or a particular topic or time period, scripted responses, labeled data, voice data, and image data. Client devices 102A-C may use a chat index to supplement the knowledge base of the digital replica, for example by enabling the digital replica to directly access or query the chat index to determine an answer or appropriate response for a specific person.

Client devices 102A-C may also be responsible for creating and applying a voice font to a chat bot. This may involve accessing voice data from social data, a personality index, or other sources, and applying speech recognition or synthesis techniques to create a voice font of a specific person. These techniques may be provided by client devices 102A-C, front end server 120, or a separate device or service. Client devices 102A-C include mobile devices module 103, web browser module 104, and API module 105. Mobile devices module 103 refers to a component or group of components that facilitate the functionality of digital avatar to be accessed on a mobile device or devices. Web browser module 104 refers to a software component that enables a user to access and interact with their digital replica using a web browser. API module 105 refers to a set of programming interfaces that allow software applications to communicate with the digital replica of a specific person. This module 105 may include a set of protocols, routines, and tools that developers can use to build software applications that interact with the hosting service 160. The voice font can then be applied to the chat bot to enable it to converse in the voice of the specific person.

The module front end server 120 in the system 100 includes speech recognition module 130. The speech recognition module 130 is used to process and interpret speech input from users. This speech input is then passed through the natural language processing (“NLP”) module 135, which contains a stored model of the specific person being hosted on the server. The NLP module 135 is used to understand and interpret the user's intent. The user response generation module 140 allows users to interact with the digital replicas, and it works in conjunction with the text generation module 145. The text generation module 145 is used to generate a textual response to the user's input, which is then passed through the speech synthesis module 150. The speech synthesis module 150 uses a trained and stored vocoder module 155 to generate an audio response in the voice font of a specific user. The hosting service module 160 contains hardware components which include servers and storage devices and software components which enable the user to interact with the digital replica. Overall, the disclosed system 100 enables users to create, interact with, and share digital replicas in a user-friendly and secure manner.

In summary, System 100 includes a blend of hardware and software components that work together to create and manipulate digital replicas that are accurate and realistic representations of the users, and the system may be implemented, as just one example, in metaverse applications.

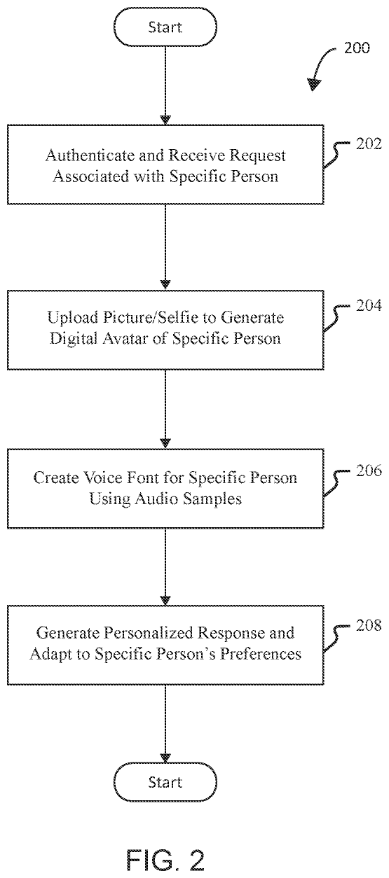

FIG. 2 illustrates a flowchart 200 for a process of generating digital replicas and voice fonts for a specific person as described herein, in accordance with one embodiment of the present invention. The figure describes a process for creating and managing digital avatars of specific individuals. The process begins with authenticating and receiving a request associated with a specific person, which is represented by step 202. This could involve logging in with a username and password or providing some other form of identification to access the system. This first step ensures that only authorized users have access to the system, protecting the privacy and security of the specific person whose avatar is being created.

Once the user is authenticated, they can upload a picture or selfie of the specific person, as represented by step 204. This captured data is then passed through a processing module, where it undergoes a rigorous analysis and processing to extract the most minute and intricate details of the person's facial features. This picture or selfie is used to generate a digital avatar of the specific person and the processed data is then consigned to a storage. This avatar can be used to represent the person in various contexts, such as virtual reality or online communication.

The next step, represented by 206, is to create a voice font for the specific person using audio samples. This may involve collecting and analyzing audio samples of the person's voice, such as recordings of their speech or audio samples. These samples are then used to train a computer model to generate speech in the person's voice, which can be used to produce personalized responses. The process described in this figure is designed in part to create and manage digital avatars of specific individuals, allowing for personalized and adaptable communication.

Finally, step 208 represents generating a personalized response and adapting it to the specific person's preferences. This could involve using the digital avatar and voice font to create a customized message or interaction that is tailored to the person's interests, needs, or preferences. The process may also use machine learning techniques to learn and adapt to the person's preferences over time. Overall, the disclosed process enables users to create and manage digital avatars of specific individuals in a personalized and adaptable manner.

Overall, FIG. 2 presents a narrative of how the process leverages processing techniques to create realistic digital replicas and voice fonts of a specific person, that are eerily similar to the specific person. It shows how our digital interactions are not only more seamless and efficient, but also more human and personal. It is a technological advancement that bridges the gap between our physical and digital selves enabling us to redefine the way we communicate with one another.

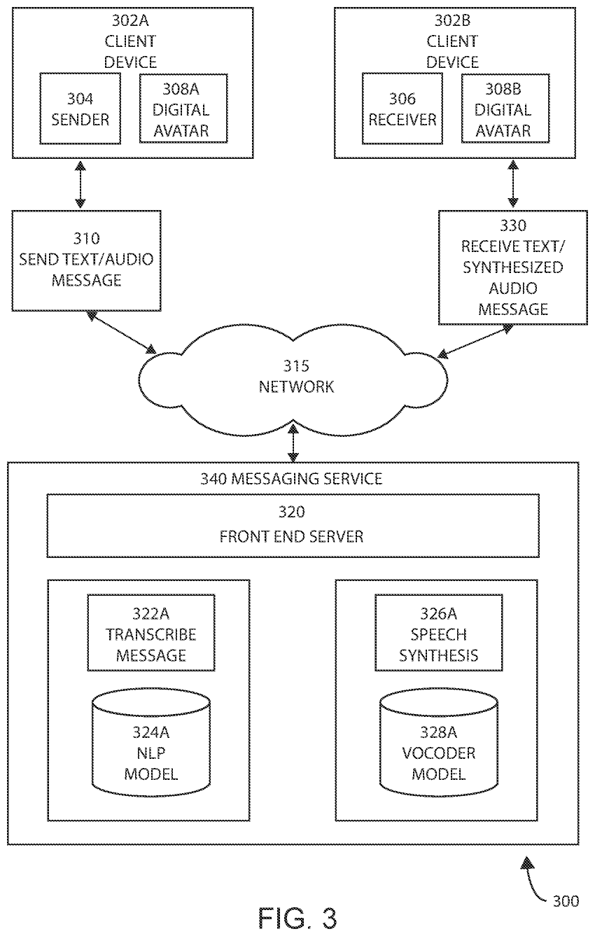

FIG. 3 illustrates a system, denoted as System 300, which includes a messaging service module 340 for enabling communication between digital replicas. The messaging can be accessed via a user interface provided by the send text/audio message module 310, which allows users to send and receive messages using their digital replicas. The messages can be in the form of text or audio messages.

The system 300 also includes a network module 315 for connecting Client Devices 302A and 3028 to the server and transmitting messages to one another over a network, such as the internet. The network module 315 allows for the seamless exchange of messages between digital replicas, regardless of their location. The system includes messaging service module 340, which serves as the conduit for communication between digital avatars 308A and 308B.

Additionally, there may be a transcribe message module 322A for analyzing, transcribing, and processing the messages, such as for language translation or sentiment analysis using the natural language processing (“NLP”) module 324A. Similarly, the speech synthesis module 326A works in conjunction with the vocoder model 328A, generating the audio in the voice font of the sender 304, enabling the receiver 306 to have the option to listen to the text message, through the digital avatar 308A of the sender 304. Alternatively the sender 304 can be reversed in the transmission role to get a response from the client, and overall, the system 300 illustrated enables user-generated digital replicas to communicate with one another, allowing them to send and receive messages in various forms, such as text, audio, or video.

The messaging service module 340 communicates with the receive text/synthesized audio message module 330, which is intuitive and user-friendly, allowing users to receive messages from their digital replicas with ease. The messages can take the form of text, audio, or video, offering users a wide range of options to express themselves. This module elevates the messaging experience by allowing for the seamless and interactive exchange of messages between people even speaking different languages, and by providing insights into the sentiment behind the message.

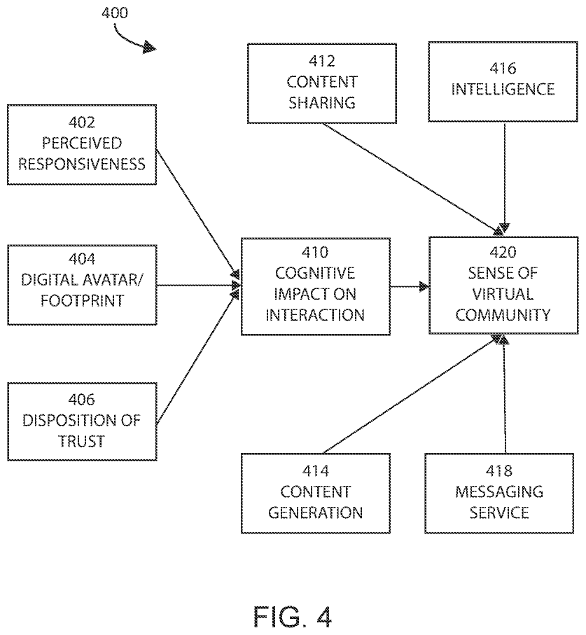

FIG. 4 illustrates a system 400 for engineering a virtual community secured by facial and voice recognition as described herein. The figure illustrates an example system for engineering a virtual community secured by facial and voice recognition, as described in the patent. The system 400 employs perceived responsiveness 402, which allows users to interact with the virtual community. The user interface can also lead to perceived responsiveness, such that the virtual community can respond to users' actions and interactions in real-time, creating a sense of immersion and engagement for the users.

The system 400 also includes a digital avatar footprint module 404, which enables users to interact with digital avatars, which are computer-generated representations of a specific individual. The system 400 also includes a disposition of trust module 406 highlighting the level of trust between the specific person and their digital avatar, which allows users to assign trust levels to other users in the virtual community and illustrates willingness to share information by the specific person.

The modules work together to create a cognitive impact on interaction as shown in module 410. The cognitive impact on interaction module 410 allows the virtual community to respond to users' actions and interactions, creating a sense of immersion and engagement for the users. The system 400 also includes a content sharing module 412, which allows users to share the content they create with other users in the virtual community and the content generation module 414, which allows users to create and upload content, such as videos, images, and text, to the virtual community.

The intelligence module 416 emulates systematic intelligence; It is a computer system that is designed to emulate human-like intelligence and is capable of performing tasks and making decisions that are typically associated with human intelligence, such as reasoning, learning, and responding. Intelligence module 416 is built on a systematic approach, meaning it follows a set of defined rules and processes to arrive at its conclusions. The intelligence module 416 has the ability to analyze data, make predictions, and adapt to new information, making it a powerful tool for various applications such as chatbot and adapting to user's preferences.

The messaging service module 418 allows users to communicate with other users in the virtual community, creating a sense of virtual community as shown in the virtual community module 420. Overall, the system 400 illustrated in FIG. 4 provides a secure and interactive virtual community experience that is secured by facial and voice recognition, allowing users to interact with digital avatars, assign trust levels, create, and share content and communicate with other users, creating a sense of belonging.

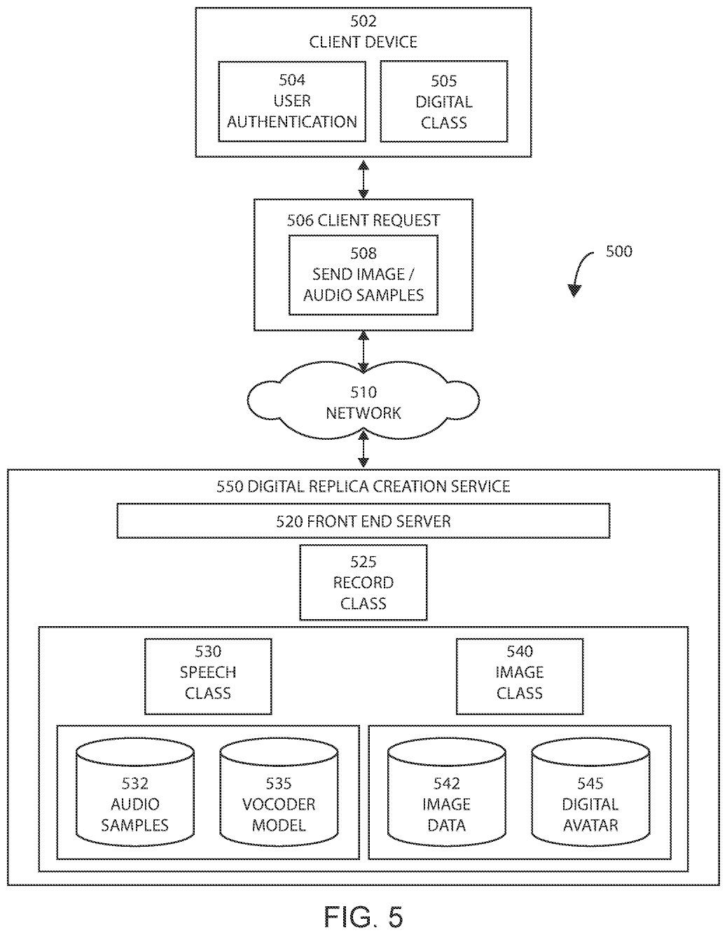

FIG. 5 depicts a system 500 that allows a user to have administrative rights to create user-generated digital replicas of a specific person. The system 500 includes both client and server components modules, working together to provide a seamless user experience for generating and managing digital replicas.

The client device module 502 is the entry point for the user and equipped with a user authentication module 504 that verifies the identity of the user. It also hosts the digital class module 505 for digital data processing for visual presentation, creation, and manipulation of graphic objects on the user's device such as display of digital replica, user interface, and options to interact with the platform. The user authentication module 504 grants access to the client request module 506 allowing the user to input specifications for the digital replica and send a request for its creation using the send image/audio samples module 508. The input information is transmitted to the server component via network module 510.

The front-end server 520 is responsible for receiving the request from the client and processing it to generate the desired digital replica for the specific person. The front-end server 520 communicates with record class module 525, which securely stores all the necessary information for creating the digital replica. Record class module 525 further communicates with the speech class module 530 which includes audio samples 532 for the specific person and their specific vocoder model 535. Moreover, record class module 525 also communicates with the image class module 540, which stores the image data 542 shared by the user along with the generated digital replica or avatar 545. This secure storage ensures that the user's data and the digital replica are protected and secure.

Additionally, the record class module 525 may also include an administrative component, which grants the user administrative rights to the system 500. This component allows the user to manage their digital replica and access related information to update or delete their data stored on the speech class module 530 or image class module 540. The digital replica creation service module 550 consists of several modules incorporating both hardware components which include servers and storage devices and software components which include databases and algorithms for the operation of digital replicas, which works in conjunction to provide users with the capability to create the digital avatar of a specific person.

The system 500 described in FIG. 5 is a comprehensive and secure solution for generating digital replicas of a specific person. The presented system 500 encompasses a comprehensive approach for facilitating the generation and management of digital replicas of specific individuals. It integrates various components to provide a user-friendly experience, from inputting the necessary specifications for the creation of the digital replica to securely preserving the related information. This integrated approach ensures a smooth and efficient process, thereby enhancing the overall user experience.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A system for creating a digital replica, comprising:
a. an image class module for image analysis, image recognition, image processing, and display of user graphical intent;
b. a speech class module for speech signal synthesis, speech storage, speech transmission, speech recognition, and display of user speech intent;
c. a digital class module for digital data processing for visual presentation, creation, and manipulation of graphic objects;
d. an intelligence class module for emulation of systematic intelligence; and
e. a record class module for record storage, organization, indexation, and retrieval through a computerized data process,
wherein the image class module receives input from one or more users through GUI elements provided by the record class module and processes the input, using the digital class module, to analyze, recognize, and display the graphical intent of the user,
wherein the speech class module communicates with the intelligence class module to recognize and display user or systematic speech intent, and
wherein the record class module stores and organizes all data processed by the other modules.

2. The system of claim 1 wherein a 3D morphable face model of the user and a unique voice font for the user are created.

3. The system of claim 2 wherein conversations with human users are simulated.

4. The system of claim 3 further includes machine learning to learn and adapt to the users preferences over time.

5. The system of claim 4 wherein administrative rights are granted to one or more of the users by identifying and verifying the identity of the users.

6. The system of claim 5 wherein digital replicas message one another, which allows the digital replicas to send and receive messages to and from one another via speech transmission, digital data processing, and by using the GUI elements.

7. The system of claim 6 further comprises user-to-user messaging in packet-switching networks, transmitted according to store-and-forward or real-time protocols.

8. A system for engineering a virtual community secured by facial and voice recognition, comprising:
a. a user interface as digital class for interacting with the system and providing input, including facial and voice likeness of a user;
b. a processor for executing various modules and securing the virtual community through real time facial and voice recognition monitoring;
c. a storage device for storing user data, including the facial and voice likenesses, for use in the virtual community; and
d. a communication module for allowing users to interact with one another within the virtual community.

9. The system of claim 8 further comprises security measures, including encrypted communication and secure authentication protocols, to ensure privacy and safety of the users within the virtual community.

10. The system of claim 9 wherein users are enrolled in the virtual community by requiring them to provide their facial and voice likenesses for verification and authentication.

11. The system of claim 10 wherein access to the virtual community is granted to the users whose facial and voice likenesses match the enrolled likenesses.

12. The system of claim 11 wherein any suspicious or unauthorized access attempts to the virtual community are monitored.

13. A method of creating a digital replica, comprising:
a. authenticating and receiving a request associated with a user;
b. capturing a visual representation of the user;
c. extracting details of the user's facial features;
d. generating a digital avatar of the user;
e. creating a voice font of the user using audio samples; and
f. training a computer model to generate speech in the user's voice, which is used to produce personalized responses.

14. The method of claim 13 wherein the user request is authenticated by the user logging in with a username and password.

15. The method of claim 14 wherein the digital avatar and the voice font are used to create a customized message or interaction that is tailored to the user's interests or preferences.

16. The method of claim 15 wherein machine learning is used for learning and adapting to the user's interests or preferences over time.

17. The method of claim 16 wherein data of the user is stored.
